(19) United States
(12) Patent Application Publication
(10) Pub. No.: US 2011/0037400 A1
(43) Pub. Date: Feb. 17, 2011

(54) Constant Current Driving Circuit for Field Emission Device

(75) Inventors: Kwang Bok Kim, Daejeon (KR); Dong Wook Yang, Daejeon (KR)

Correspondence Address: WOMBLE CARLYLE SANDRIDGE & RICE, PLLC, ATTN: IP DOCKETING, P.O. BOX 7037, ATLANTA, GA, 30357-0037, US

(73) Assignee: Kumho Electric, Inc., Seoul (KR)

(21) Appl. No.: 12/770,384

(22) Filed: Apr. 29, 2010

Related U.S. Application Data
(63) Continuation of application No. PCT/KR2007/005465, filed on Oct. 31, 2007.

(30) Foreign Application Priority Data
Oct. 31, 2007 (KR) 10-2007-0110595

(51) Int. Cl. H05B 41/16

(52) U.S. Cl. 315/246

(57) ABSTRACT

A constant current driving circuit for a field emission device has a ground current of an anode electrode measured in real time and the measured ground current is fedback to vary the frequency and duty ratio of a voltage applied to gate and cathode electrodes of the field emission device, thereby causing the ground current of the anode electrode to be constantly maintained. The field emission device has an anode electrode formed on a front substrate, gate and cathode electrodes formed on a rear substrate disposed opposite to the front substrate to be spaced apart from the front substrate by a predetermined distance, and an emitter formed on a top surface of the cathode electrode. The constant current driving circuit includes current detection circuit for detecting a ground current of the anode electrode; an input power unit for applying a driving AC voltage for emitting electrons from the emitter to the gate and cathode electrodes; and a feedback circuit unit for comparing the ground current of the anode electrode detected by the current detection circuit with a predetermined reference voltage to obtain a current variation and providing the input power unit with a frequency signal for varying a frequency of the driving AC voltage or a duty ratio signal for varying a duty ratio of the driving AC voltage in accordance with the current variation.

### RELATED APPLICATIONS

This is a Continuation of PCT/KR2007/005465, filed Oct. 31, 2007, which published in English as WO 2009/057837A1 on May 7, 2009, and claims priority to KR 10-2007-0110595, also filed Oct. 31, 2007. The contents of the aforementioned PCT and Korean applications are incorporated by reference.

### FIELD OF THE INVENTION

The present invention relates to a constant current driving circuit for a field emission device, and more particularly, to a constant current driving circuit for a field emission device, wherein a ground current of an anode electrode is measured in real time and the measured ground current is fedback to vary the frequency and duty ratio of a voltage applied to gate and cathode electrodes of a field emission device, thereby causing the ground current of the anode electrode to be constantly maintained.

### BACKGROUND

Recently, the development of thin film displays using field emission has been actively conducted as lightweight and thin flat panel displays capable of substituting for conventional cathode ray tubes (CRTs).

Field emission devices are classified into a diode structure type and a triode structure type. The field emission device having a diode structure has an advantage in that it can be easily manufactured and have a large light emitting area. However, the field emission device having a diode structure requires a high driving voltage and has a low light emitting efficiency. Therefore, the field emission device having a triode structure has been mainly used in recent years.

In the field emission devices with a triode structure, a gate electrode that serves as a subsidiary electrode is spaced apart from a cathode electrode by a distance of some tens of nanometers (nm) to some centimeters (cm) in order to easily extract electrons from a field emission material.

FIG. 1 is a view showing a conventional field emission device having a triode structure. Referring to FIG. 1, cathode electrodes 2 are formed on a surface of a rear substrate 1, and emitters 3 are formed on a top surface of the cathode electrodes 2. Gate electrodes 4 are spaced apart from the cathode electrodes 2 by a predetermined distance and formed on the rear substrate 1 with insulating layers 5 interposed therebetween. A front substrate 6 is formed opposite to the rear substrate 1, and a phosphor layer 7 and an anode electrode 8 are formed on the front substrate 6. Anode and gate voltages for driving the field emission device are supplied by means of DC and AC inverters 9 and 10, respectively.

At this time, in the conventional field emission device, over-current may be supplied due to external shock and malfunction of a driving circuit. As a result, the insulating layer may be damaged or broken, and a short circuit between the gate and cathode electrodes may occur.

In addition, since current in the gate electrode is not constant, there is a problem in that a luminance difference may occur depending on a position of a screen of the field emission device.

The present invention is conceived to solve the aforementioned problems. The present invention is to provide a constant current driving circuit for a field emission device, wherein a ground current of an anode electrode is measured in real time and the measured ground current is fedback to vary the frequency and duty ratio of a voltage applied to gate and cathode electrodes of a field emission device, thereby causing the ground current of the anode electrode to be constantly maintained.

### SUMMARY OF THE INVENTION

According to an aspect of the present invention, there is provided a constant current driving circuit for a field emission device having an anode electrode formed on a front substrate, gate and cathode electrodes formed on a rear substrate disposed opposite to the front substrate to be spaced apart from the front substrate by a predetermined distance, and an emitter formed on a top surface of the cathode electrode. The constant current driving circuit comprises a current detection circuit for detecting a ground current of the anode electrode; an input power unit for applying a driving AC voltage for emitting electrons from the emitter to the gate and cathode electrodes; and a feedback circuit unit for comparing the ground current of the anode electrode detected by the current detection circuit with a predetermined reference voltage to obtain a current variation and providing the input power unit with a frequency signal for varying a frequency of the driving AC voltage or a duty ratio signal for varying a duty ratio of the driving AC voltage in accordance with the current variation.

At this time, the feedback circuit unit may provide the input power unit with the frequency and duty ratio signals.

Preferably, the input power unit comprises a power supply for receiving and rectifying an AC voltage; a power driver for receiving a DC voltage from the power supply and generating an AC voltage, the frequency and duty ratio of the generated AC voltage being determined by the frequency and duty ratio signals input from the feedback circuit unit; and a high-voltage generator for receiving and boosting the AC voltage generated in the power driver to generate the driving AC voltage.

More preferably, the feedback circuit unit comprises a frequency variable unit for outputting the frequency signal; a duty ratio variable unit for outputting the duty ratio signal; and a frequency comparator for detecting the frequency of the driving AC voltage from the frequency signal output from the frequency variable unit and comparing the detected frequency with a limit frequency.

Still more preferably, when the frequency of the driving AC voltage exceeds the limit frequency, the frequency of the driving AC voltage is fixed to be the limit frequency and only the duty ratio is varied.

A constant current driving circuit for a field emission device according to the present invention, a ground current of an anode electrode is measured in real time and the measured ground current is fedback to vary the frequency and duty ratio of a voltage applied to gate and cathode electrodes of a field emission device, thereby causing the ground current of the anode electrode to be constantly maintained. As a result, it is possible to increase the light emitting uniformity of the field emission device, to lengthen the life span of the field emission device, and increase the stability of the field emission device.

### BRIEF DESCRIPTION OF THE DRAWINGS

FIG. 1 is a view of a conventional field emission device with a triode structure.

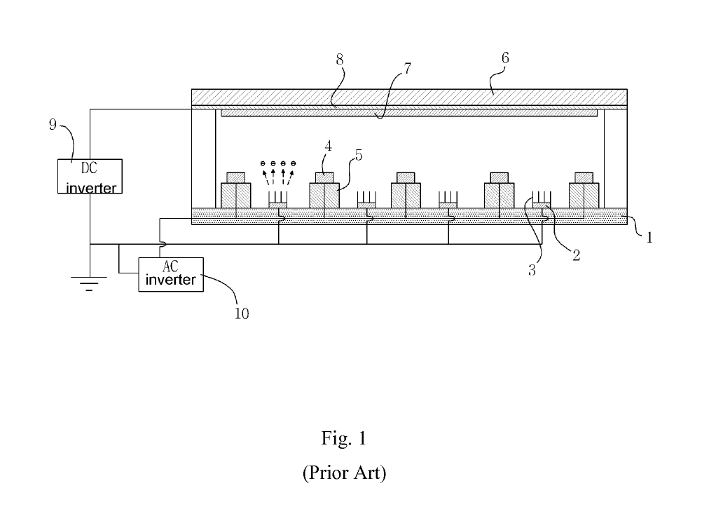

FIG. 2 is a view of a constant current driving circuit for a field emission device according to the present invention.

FIG. 3 is a detailed diagram of a feedback circuit unit.

FIG. 4 is a waveform diagram of a driving AC voltage with a frequency varied.

FIG. 5 is a waveform diagram of a driving AC voltage with a duty ratio varied.

### DETAILED DESCRIPTION

Hereinafter, the present invention will be described in detail with reference to the accompanying drawings.

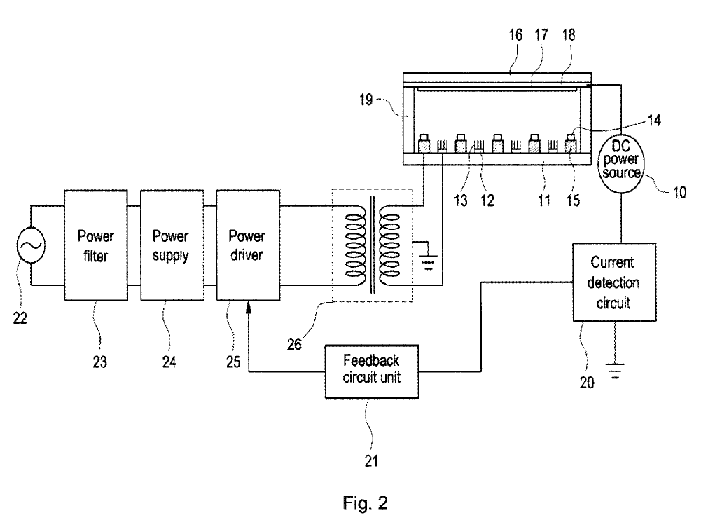

FIG. 2 is a view of a constant current driving circuit for a field emission device according to the present invention. Referring to FIG. 2, a lateral gate type field emission device configured such that a gate electrode is positioned at a side of a cathode electrode is driven by the constant current driving circuit according to the present invention.

First, the lateral gate type field emission device will be described. Front and rear substrates 16 and 11 are disposed opposite to each other while being spaced apart from each other at a predetermined distance. The front and rear substrates 16 and 11 are insulative substrates. Although glass, alumina, quartz or silicon wafers may be used as the front and rear substrates, glass substrates are preferably used in consideration of a manufacturing process and a large size.

At least one cathode electrode 12 made of a metal is formed on the rear substrate 11 and generally has a stripe shape.

An emitter 13 from which electrons are emitted is formed on a top surface of each cathode electrode 12. The emitter 13 may be formed of any one of metal, nano-carbon, carbide and nitride compounds.

At least one insulator 15 is formed on the rear substrate 11 to be spaced apart from the cathode electrode electrodes 12, and a gate electrode 14 is formed on a top surface of each insulator 15.

An anode electrode 18 is formed on the front substrate 16 disposed opposite to the rear substrate 11 to face the rear substrate 11. The anode electrode 18 is generally formed of a transparent conductive layer such as indium tin oxide (ITO).

A phosphor layer 17 having R, G and B phosphors mixed at a predetermined ratio is applied on the anode electrode 18.

Frit glasses 19 are formed between the rear and front substrates 11 and 16 to support them and to maintain vacuum-tight seal.

A DC power source 10 connected to the anode electrode 18 is used to accelerate electrons emitted from the emitters 13, and generally includes a DC voltage source.

At this time, the ground current of the anode electrode 18 is influenced by the number of electrons emitted from the emitters 13. Since electrons are emitted from the emitters 13 by a driving AC voltage applied to the gate and cathode electrodes 14 and 12, the ground current of the anode electrode 18 can be controlled by controlling the driving AC voltage applied to the gate and cathode electrodes 14 and 12.

Hereinafter, the configuration and operation of the constant current driving circuit will be described.

The constant current driving circuit performs an operation of varying the frequency and duty ratio of a driving AC voltage applied to the gate and cathode electrodes 14 and 12 in the field emission device in order to keep the ground current of the anode electrode 18 to be constant.

Referring to FIG. 2, the constant current driving circuit comprises a current detection circuit 20, an input power unit and a feedback circuit unit 21.

The current detection circuit, which is a circuit for detecting the ground current of the anode electrode 18, may be implemented using a resistor. Thus, the ground current of the anode electrode 18 detected by the current detection circuit is generally converted into a voltage and then output.

The input power unit is used to apply a driving AC voltage for emitting electrons from the emitters 13 to the gate and cathode electrodes 14 and 12 in the field emission device, and comprises a power filter 23, a power supply 24, a power driver 25 and a high-voltage generator 26.

The power filter 23 is a unit for receiving a general AC commercial voltage input from an input power source 22 and removing noises. The power filter 23 outputs the AC commercial voltage with noises removed to the power supply 24.

The power supply 24 receives and rectifies the AC commercial voltage in which noises are removed by the power filter 23, and outputs the rectified AC common voltage. The power supply 24 includes a converter for converting an AC voltage into a DC voltage.

The power driver 25 receives a DC voltage from the power supply 24, generates an AC voltage, and outputs the AC voltage to the high-voltage generator 26. The high-voltage generator 26 boosts the input AC voltage at an appropriate level to be applied to the gate and cathode electrodes 14 and 12 in the field emission device, and outputs the boosted AC voltage. The AC voltage output from the high-voltage generator 26 is applied to the gate and cathode electrodes 14 and 12 of the field emission device to function as a driving AC voltage for emitting electrons from the emitter 13 formed on the top surface of each of the cathode electrodes 12.

The frequency and duty ratio of the AC voltage generated in the power driver 25 is determined by the feedback circuit unit 21 which will be described below.

The feedback circuit unit 21 receives the ground current detected by the current detection circuit 20, compares the input ground current with a reference current to obtain a current variation, and adjusts the frequency and duty ratio of the driving AC voltage applied to the gate and cathode electrodes 14 and 12 of the field emission device in accordance with the current variation.

At this time, the reference current means the ground current of the anode electrode 18 designed when the field emission device is in a normal state. The reference current may have different values depending on materials of the electrodes 12, 14 and 18 and the emitter 13, which are formed in the field emission device.

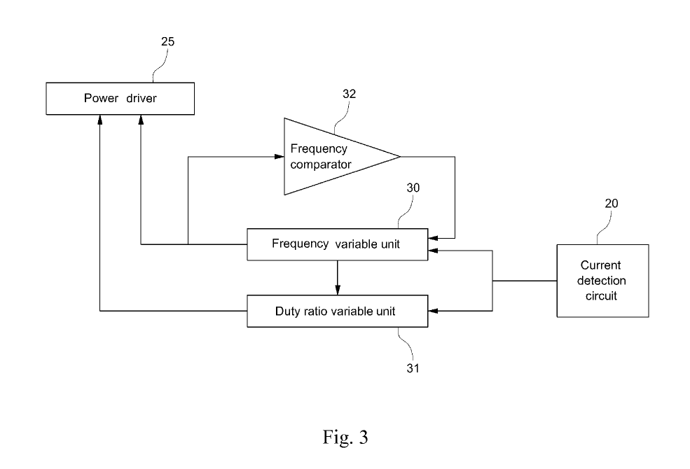

As shown in a detailed diagram of the feedback circuit unit of FIG. 3, the feedback circuit unit 21 comprises a frequency variable unit 30, a duty ratio variable unit 31 and a frequency comparator 32.

The frequency variable unit 30 receives the ground current detected in the current detection circuit 20, compares the input ground current with a reference current to obtain a current variation, and outputs a frequency signal for varying the frequency of the driving AC voltage in accordance with the current variation. Thus, a value of a predetermined reference current is stored in the frequency variable unit 30.

Specifically, when the ground current detected in the current detection circuit 20 is smaller than the reference current, the frequency variable unit outputs a frequency signal for increasing the frequency of the driving AC voltage. Contrarily, when the ground current is greater than the reference current, the frequency variable unit outputs a frequency signal for decreasing the frequency of the driving AC voltage. That is, the frequency signal is a medium signal for determining the frequency of the AC voltage generated in the power driver 25, and contains information on a frequency of a driving AC voltage.

The duty ratio variable unit 31 is to output a duty ratio signal for varying the duty ratio of a driving AC voltage in accordance with a current variation, wherein the value of the reference current is stored in the duty ratio variable unit like the frequency variable unit 30. When the ground current is smaller than the reference current, the duty ratio variable unit 31 outputs a duty ratio signal for increasing the duty ratio of the driving AC voltage. Contrarily, when the ground current is greater than the reference current, the duty ratio variable unit 31 outputs a duty ratio signal for decreasing the duty ratio of the driving AC voltage. Thus, the duty ratio signal is a medium signal for determining the duty ratio of the AC voltage generated in the power driver, and contains information on a duty ratio of a driving AC voltage.

The number of electrons emitted from the emitters 13 of the field emission device is influenced by the frequency or duty ratio of the driving AC voltage. It is preferable to first vary the frequency of the driving AC voltage. Specifically, the frequency of the driving AC voltage is first varied in accordance with the current variation. However, if the frequency of the driving AC voltage exceeds a predetermined limit frequency, it is preferable to fix the frequency of the driving AC voltage to be the limit frequency and then vary only the duty ratio thereof.

The limit frequency is determined in consideration of properties and the like of a material constituting the emitters 13 of the field emission device.

The process of comparing the frequency of the driving AC voltage with the limit frequency is performed in the frequency comparator 32 included in the feedback circuit unit 21. That is, the limit frequency is stored in the frequency comparator 32, a frequency signal output from the frequency variable unit 30 is fedback to the frequency comparator 32, and the frequency comparator 32 extracts information on the frequency of the driving AC voltage contained in the frequency signal and compares the frequency of the driving AC voltage with the limit frequency.

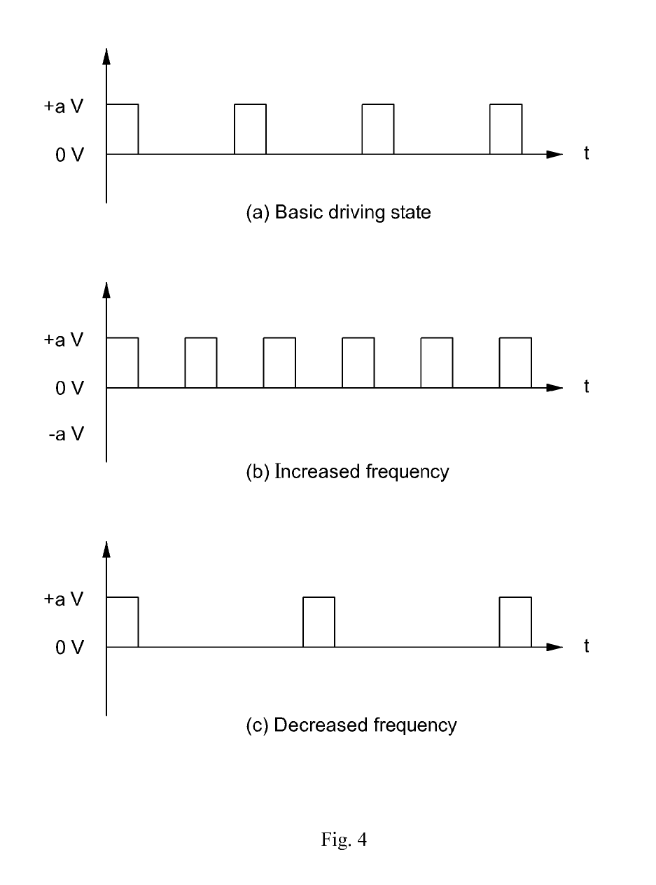

FIG. 4 is a waveform diagram of a driving AC voltage with a frequency varied, in which the waveform of the driving AC voltage has a rectangular shape as an example. In FIG. 4, a basic driving state means when the ground current of the anode electrode 18 has the same value as the reference current. As shown in FIG. 4, when the ground current of the anode electrode is smaller than the reference current, the frequency of the driving AC voltage is increased so as to increase the current of the anode electrode. On the contrary, when the ground current of the anode electrode is greater than the reference current, the frequency of the driving AC voltage is decreased so as to decrease the ground current of the anode electrode. However, it is preferred that the high-level holding time of the driving AC voltage be constantly maintained in the frequency variation process of FIG. 4.

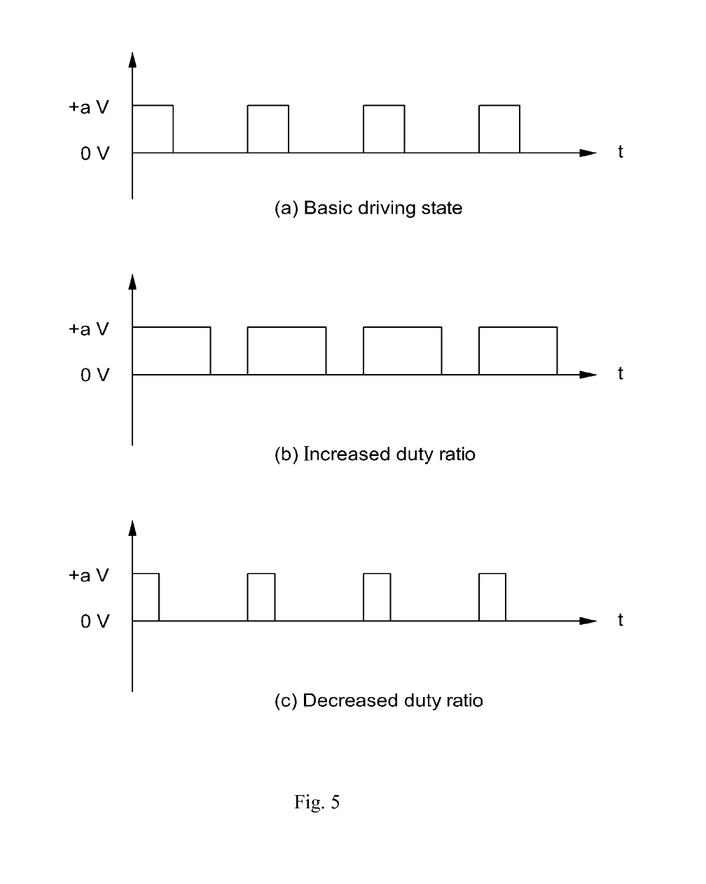

FIG. 5 is a waveform diagram of a driving AC voltage with a duty ratio varied. As shown in FIG. 5, the duty ratio is increased when it is required to increase the ground current of the anode electrode 18, whereas the duty ratio of the driving AC voltage is decreased when it is required to decrease the ground current of the anode electrode. However, in the duty ratio variation process of FIG. 5, the frequency of the driving AC voltage is maintained the same as that in the basic driving state. As described above, the frequency of the driving AC voltage is first varied in accordance with the current variation. However, if the frequency of the driving AC voltage exceeds a predetermined limit frequency, it is preferable to fix the frequency of the driving AC voltage to be the limit frequency and then vary only the duty ratio thereof.

Since the frequency and duty ratio variation processes as described above are repeatedly performed, the value of the driving AC voltage is adjusted in real time depending on the value of the ground current of the anode electrode 18, so that the ground current of the anode electrode 18 can be constantly maintained.

According to the present invention, in a constant current driving circuit for a field emission device, a ground current of an anode electrode is measured in real time and the measured ground current is fedback to vary the frequency and duty ratio of a voltage applied to gate and cathode electrodes of a field emission device, thereby causing the ground current of the anode electrode to be constantly maintained. As a result, it is possible to increase the light emitting uniformity of the field emission device, to lengthen the life span of the field emission device, and increase the stability of the field emission device.

What is claimed is:

1. A constant current driving circuit for a field emission device having an anode electrode formed on a front substrate, gate and cathode electrodes formed on a rear substrate disposed opposite to the front substrate and spaced apart from the front substrate by a predetermined distance, and an emitter formed on a top surface of the cathode electrode, the constant current driving circuit comprising:
a current detection circuit for detecting a ground current of the anode electrode;
an input power unit for applying a driving AC voltage for emitting electrons from the emitter to the gate and cathode electrodes; and
a feedback circuit unit for:
(a) comparing the ground current of the anode electrode detected by the current detection circuit with a predetermined reference voltage to obtain a current variation; and
(b) providing the input power unit with a frequency signal for varying a frequency of the driving AC voltage or a duty ratio signal for varying a duty ratio of the driving AC voltage, or both, in accordance with the current variation.

2. The constant current driving circuit as claimed in claim 1, wherein the feedback circuit unit provides the input power unit with the frequency and duty ratio signals.

3. The constant current driving circuit as claimed in claim 2, wherein the feedback circuit unit comprises:
a frequency variable unit for outputting the frequency signal;
a duty ratio variable unit for outputting the duty ratio signal; and
a frequency comparator for detecting the frequency of the driving AC voltage from the frequency signal output from the frequency variable unit and comparing the detected frequency with a limit frequency.

4. The constant current driving circuit as claimed in claim 3, wherein when the frequency of the driving AC voltage exceeds the limit frequency, the frequency of the driving AC voltage is fixed to be the limit frequency and only the duty ratio is varied.

5. The constant current driving circuit as claimed in claim 2, wherein the input power unit comprises:
a power supply for receiving and rectifying an AC voltage;
a power driver for receiving a DC voltage from the power supply and generating an AC voltage, the frequency and duty ratio of the generated AC voltage being determined by the frequency and duty ratio signals input from the feedback circuit unit; and
a high-voltage generator for receiving and boosting the AC voltage generated in the power driver to generate the driving AC voltage.

6. The constant current driving circuit as claimed in claim 5, wherein the feedback circuit unit comprises:
a frequency variable unit for outputting the frequency signal;
a duty ratio variable unit for outputting the duty ratio signal; and
a frequency comparator for detecting the frequency of the driving AC voltage from the frequency signal output from the frequency variable unit and comparing the detected frequency with a limit frequency.

7. The constant current driving circuit as claimed in claim 6, wherein when the frequency of the driving AC voltage exceeds the limit frequency, the frequency of the driving AC voltage is fixed to be the limit frequency and only the duty ratio is varied.
